(19) United States
(12) Patent Application Publication
(10) Pub. No.: US 2012/0006032 A1
(43) Pub. Date: Jan. 12, 2012

(54) SYSTEMS, METHODS, AND APPARATUS FOR CONFIRMING IGNITION IN A GAS TURBINE

(75) Inventors: Scott Alan Kopcho, Atlanta, GA (US); Garth Curtis Frederick, Greenville, SC (US); Timothy Andrew Healy, Greenville, SC (US)

(73) Assignee: GENERAL ELECTRIC COMPANY, Schenectady, NY (US)

(21) Appl. No.: 12/830,644

(22) Filed: Jul. 6, 2010

(51) Int. Cl. F02C 7/264; G01M 15/14

(52) U.S. Cl. 60/772; 60/734; 73/112.01

(57) ABSTRACT

Certain embodiments of the invention may include systems, methods, and apparatus for confirming ignition in a gas turbine. According to an example embodiment of the invention, a method is provided for confirming ignition associated with a gas turbine combustor. The method can include receiving one or more permissive signals associated with one or more gas flow control valves, receiving one or more fuel supply pressure signals, receiving one or more fuel igniter signals, and receiving one ore more compressor pressure discharge (CPD) signals. The method can also include determining an ignition status associated with the gas turbine combustor based at least in part on the one or more permissive signals, the one or more fuel supply pressure signals, the one or more fuel igniter signals, and a qualified change in the one or more CPD signals. The method can also include outputting an ignition status signal based on the determined ignition status.

### FIELD OF THE INVENTION

This invention generally relates to gas turbines, and specifically to systems, methods, and apparatus for confirming ignition in a gas turbine.

### BACKGROUND OF THE INVENTION

Gas turbines are used commercially to provide power for various commercial applications. Small annular turbines, for example, are utilized to provide thrust for aircraft, and larger can annular combustor turbines can be used, for example, in power production facilities to generate electricity.

A typical turbine is powered by a burner or a set of burners that combust fuels, such as oil or gas. In commercial facilities, there may be multiple burners operating within a single combustor. A control system may be used in association with the turbine burners and fuel supply system to maintain safe and optimum operating conditions. For example, during startup or shutdown, a burner may need to be ignited or extinguished in coordination with fuel flow to maintain safety. It may be also be desirable to turn burners on or off selectively, depending on the turbine load to maintain usage efficiency. It is therefore, important to know if a burner is on or off at any given time to maintain suitable operation of the control system and the fuel supply.

Certain reliability issues can also arise, for example, due to non-uniform thermal expansion of hot gas path parts when one or more cans of the combustion system fail to ignite. Burner ignition failures can also lead to dangerous conditions and increased explosion risks, particularly when a large amount of un-ignited fuel builds up within gas turbine flow path.

### BRIEF SUMMARY OF THE INVENTION

Some or all of the above needs may be addressed by certain embodiments of the invention. Certain embodiments of the invention may include systems, methods, and apparatus for confirming ignition in a gas turbine.

According to an example embodiment of the invention, a method is provided for confirming ignition associated with a gas turbine combustor. The method may include receiving one or more permissive signals associated with one or more gas flow control valves, receiving one or more fuel supply pressure signals, receiving one or more igniter signals, and receiving one or more compressor pressure discharge (CPD) signals. The method may also include determining an ignition status associated with the gas turbine combustor based at least in part on the one or more permissive signals, the one or more fuel supply pressure signals, the one or more igniter signals, and a qualified change in the one or more CPD signals. The method may include outputting an ignition status signal based on the determined ignition status.

According to another example embodiment, a system is provided for confirming ignition associated with a gas turbine. The system includes at least one gas turbine combustor, a plurality of sensors for detecting one or more parameters associated with the gas turbine combustor. The one or more parameters may include one or more permissive signals associated with one or more gas flow control valves, at least one fuel supply pressure signal, at least one igniter signal, and at least one compressor pressure discharge (CPD) signal. The system may also include at least one processor configured to receive the one or more parameters from the plurality of sensors, determine an ignition status associated with the gas turbine combustor based at least in part on the one or more permissive signals, the at least one fuel supply pressure signal, the at least one igniter signal, and a qualified change in the at least one CPD signal. The at least one processor is further configured to output an ignition status signal based on the determined ignition status.

According to another example embodiment, an apparatus is provided for confirming ignition associated with a gas turbine. The apparatus includes at least one processor configured to receive one or more parameters from a plurality of sensors associated with the gas turbine combustor, wherein the one or more parameters include one or more permissive signals associated with one or more gas flow control valves, at least one fuel supply pressure signal, at least one igniter signal, and at least one compressor pressure discharge (CPD) signal. The at least one processor is further configured to determine an ignition status associated with the gas turbine combustor based at least in part on the one or more permissive signals, the at least one fuel supply pressure signal, the at least one igniter signal, and a qualified change in the at least one CPD signal. The at least one processor is also configured to output an ignition status signal based on the determined ignition status.

Other embodiments and aspects of the invention are described in detail herein and are considered a part of the claimed invention. Other embodiments and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a block diagram of an illustrative control system according to an example embodiment of the invention.

FIG. 2 is a block diagram of an illustrative ignition detection process, according to an example embodiment of the invention.

FIG. 3 is a flow diagram of an example method flow diagram, according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. Certain embodiments of the invention may enable control of systems associated with a gas turbine. According to certain example embodiments of the invention, flame ignition in a gas turbine may be detected and confirmed. In certain embodiments of the invention, the confirmation of presence or absence of a burner flame may be utilized to further control system associated with the turbine, such as fuel control, safety, startup sequencing, shutdown sequencing, etc.

Successful combustor light-off (ignition followed by flame stabilization) and suitable cross-fire (ignition between combustors in a can-annular combustion system) may be detected based on real-time cycle pressure and temperature measurements. Conversely, failure to light-off and/or properly cross-fire may be likewise detected with pressure and temperature sensors.

Ignition of a gas turbine cross-fired can-annular combustion system may involve setting fuel flow rates and airflow rates to create a combustible mixture in the reaction zone of a combustor. The fuel in the combustor may be ignited by activating one or more spark igniters in one or more combustion cans. Spark igniters may remain active for a fixed period of time, or until the flame (including cross-firing) is detected.

According to an example embodiment of the invention, cycle pressure and temperature signals from existing gas turbine instrumentation (e.g. compressor discharge pressure, exhaust temperature thermocouples, combustor static or dynamic pressures) may be monitored, analyzed, and processed to reliably determine the success or failure of light-off. In an example embodiment, exhaust temperature spreads (approximately defined as a difference between maximum and minimum temperature measurement around the annulus) can also be utilized to detect the absence of flame in one or more combustion cans.

Various sensors, signals, and systems for detecting and confirming burner flame ignition and/or cross firing, according to example embodiments of the invention, will now be described with reference to the accompanying figures.

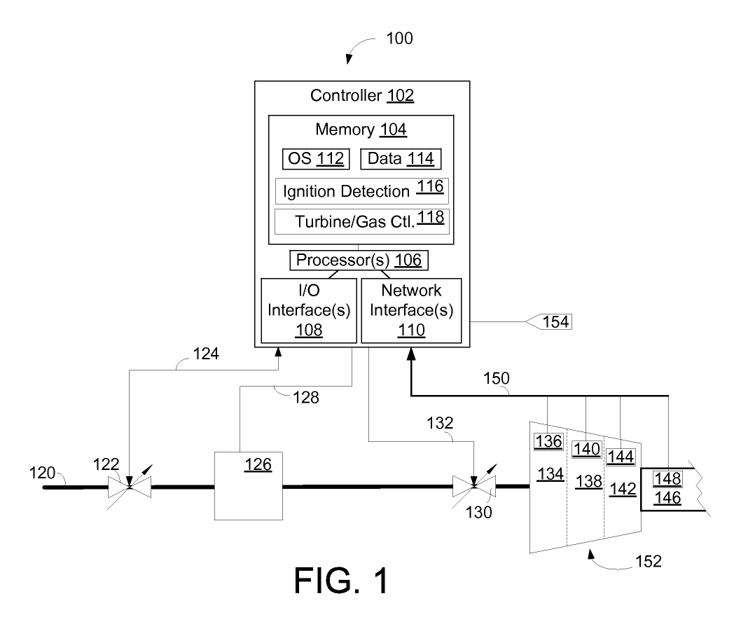

FIG. 1 illustrates an example control system 100 associated with a gas turbine system 152 and a fuel supply line 120. According to example embodiments of the invention, a controller 102 may receive, process, and output signals associated with the operation of the gas turbine system 152. In the example embodiment shown in FIG. 1, the controller 102 may include a memory 104, one or more processors 106, and one or more input/output interfaces 108. Certain embodiments of the controller 102 may include one or more network interfaces 110. According to an example embodiment of the invention, the memory 104 may include an operating system 112, data 114, an ignition detection module 116, and a turbine/gas control module 118.

According to an example embodiment of the invention, and as depicted in FIG. 1, the controller 102 may be operable to receive various signals from components associated with a gas turbine system 152, including components associated with the fuel supply line 120. For example, the controller 102 may receive valve indication signals from sensors associated with the gas pressure valve 122, and the controller 102 may be operable to control the gas pressure valve 122 with a valve control signal 124. According to example embodiments of the invention, the fuel pressure sensors 126 may be utilized to sense the pressure in the fuel line 120, and the fuel sensor signals 128 may be monitored by the controller 102.

In accordance with certain embodiments of the invention, the controller 102 may also provide a gas flow valve control signal 132 or setting and/or adjusting a gas flow valve 130. The gas flow valve control signal 132 may be derived based on a number of inputs and other control permissive signals, including a detection of flame ignition, as will be described further in detail below. According to example embodiments of the invention, the controller 102 may also monitor signals from other temperature, airflow, and pressure sensors (136, 140, 144, 148) associated with respective components of the gas turbine system 152, including sensors in the compressor 134, the combustor 138, the turbine, 142, and the exhaust system 146. According to an example embodiment, additional sensors 154 and or control signals may be utilized by the controller 102 in the operation of the gas turbine system 152.

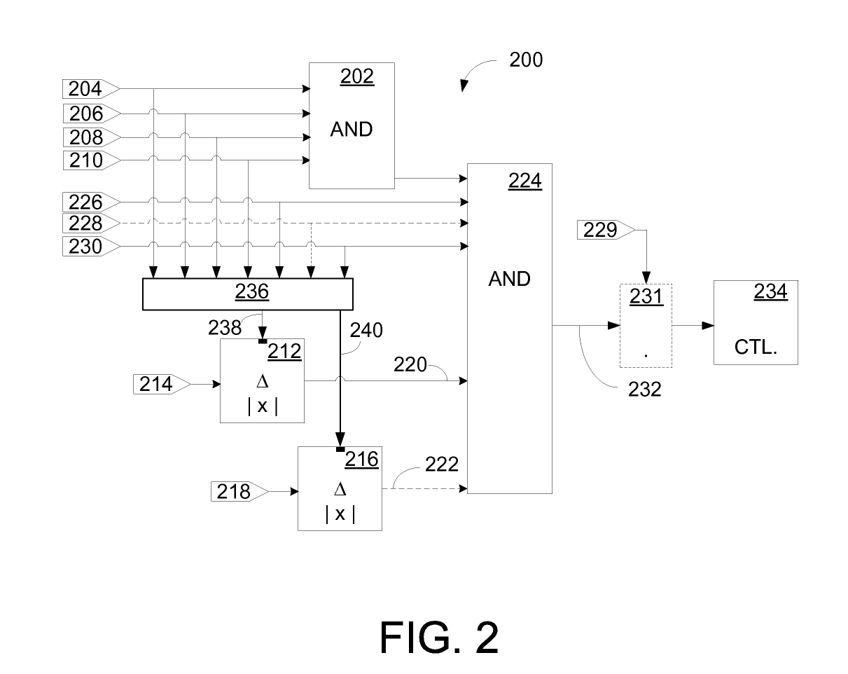

FIG. 2 depicts an example ignition detection process 200, according to an example embodiment of the invention. In accordance with an example embodiment of the invention, the detection and confirmation of burner ignition and/or burner cross firing may be prerequisite conditions for continuing a startup sequence associated with the operation of a turbine. According to an example embodiment, the operation of the turbine may also rely on the continued confirmation of burner flame conditions.

In accordance with example embodiments of the invention, a turbine start-up procedure may include receiving one or more master valve permissive signals (204-210). Example master valve permissive signals (204-210) may include logic signals that indicate state parameters associated with the turbine, the fuel line, the control system, and/or the sensors. For example, one master valve permissive signal 204 may be logical true when one or more components associated with the gas turbine have reached a predetermined threshold, or are operating within a predetermined range that would indicate a safe condition for starting the turbine. Another example master valve permissive signal 206 may be associated with airflow, for example, as measured in the compressor 134, and may be logical true when the airflow has reached a predetermined range or threshold. According to example embodiments of the invention, any number of permissive signals may be received. In certain embodiments of the invention, all of the master valve permissive signals (204-210) must be true in order for the processing and logic to continue to a subsequent step in the start-up procedure.

FIG. 2 indicates additional signals that may be utilized in the detection of the burner ignition and the turbine start-up procedure. For example, a fuel supply pressure signal 226, a valve position signal 228, and/or an igniter signal 230 may be received and evaluated in the start-up procedure. Additionally, one or more fuel supply valve position signals (as in 124 of FIG. 1) may be utilized for determining a status associated with the gas turbine combustor. In accordance with an example embodiment, the master valve permissive signals (204-210), the fuel supply pressure signal 226, the valve position signal 228, and the igniter signal 230 may all be evaluated by an enable logic block 236, and if each of these signals are logical true, then additional processing blocks (212, 216) associated with the startup and/or burner ignition detection may be enabled. For example, a compressor discharge pressure (CPD) evaluation block 212 and/or an exhaust temperature evaluation block may respectively receive a CPD evaluation enable signal 238 and an exhaust evaluation enable signal 240 if all signals entering the enable logic AND block 236 are logic true.

In accordance with an example embodiment of the invention, when enabled, the compressor discharge pressure (CPD) evaluation block 212 may receive and evaluate one or more CPD signals 214 to determine if the compressor discharge pressure has changed. In an example embodiment, the CPD signal 214 may be evaluated for detecting a change indicative of ignition or extinction of the burner flame. In an example embodiment, the CPD signal 214 may be monitored and evaluated by evaluation block 212, and a CPD ignition indication signal 220 may be output when the evaluated CPD signal has undergone a qualified change. In an example embodiment, the qualified change may be defined as a change above a predetermined threshold in the absolute value of the CPD signal 214.

In an example embodiment, the CPD signal 214 may be sampled over a period of time to determine noise characteristics associated with the signal 214. In an example embodiment, a predetermined threshold for triggering a qualified change may include a CPD signal change of greater than about 4 times a noise standard deviation associated with the CPD signal 214. In certain embodiments, such a predetermined threshold may indicate burner ignition or extinction. According to example embodiments of the invention, the CPD evaluation block 212 may provide a CPD ignition indication signal 220 for input to a control AND block 224.

In accordance with an example embodiment of the invention, the exhaust temperature evaluation block 216 may receive and evaluate one or more exhaust temperature signals 218 to determine if the if the exhaust temperature has undergone a change indicative of burner ignition or extinction. In an example embodiment, and as described above with reference to the CPD signal 124, the exhaust temperature signals 218 may also be monitored and evaluated for detecting a qualified change. In an example embodiment, a qualified change indicative of successful ignition may include a temperature rise of greater than about 200 degrees Fahrenheit (about 93 degrees Centigrade) over a time period ranging from about 5 seconds to about 20 seconds. According to example embodiments of the invention, exhaust temperature evaluation block 216 may provide a logic exhaust temperature indication signal 220 for input to the control AND block 224.

In an example embodiment of the invention, incomplete cross firing of multiple burners within a combustor 138 may also be determined by monitoring an exhaust spread signal 229. In an example embodiment, the exhaust spread signal 229 may indicate extinction or lack of ignition of one or more burners when the exhaust spread signal 229 does not settle below a threshold of approximately 60 degrees F. within approximately 60 seconds after ignition. According to an example embodiment, the cross firing detection process may be enabled based on the ignition status signal 232. For example, an optional cross fire detection block 231 may be initiated after ignition has been determined. According to another example embodiment, the optional cross fire detection block 231 may be initiated when the exhaust temperature reaches or exceeds a predetermined threshold. In an example embodiment, the optional cross fire detection block 231 may utilize the ignition status signal 232 as a permissive to check for cross fire by looking at how the exhaust spreads decrease in time.

According to an example embodiment of the invention, if all inputs to the control AND block 224 are logic true, the detection system may conclude that a flame has been established. In this case, an ignition status signal 232 may be sent directly to the gas turbine controller 234 to allow the turbine start sequence to proceed. According to an alternative example embodiment, the ignition status signal 232 may be utilized as a permissive by the optional cross fire detection block 231 to enable checking if cross-firing has occurred and is maintained. According to example embodiments of the invention, if a flame is not established in an allotted time, or if cross firing is not detected and maintained, the gas turbine controller 234 may shut off gas valves, or otherwise commence a turbine shutdown procedure.

According to example embodiments of the invention, the ignition status signal 232 may be further controlled during operation of the turbine via continuous monitoring of the CPD signal 214, the exhaust temperature signal 218, and/or the exhaust spread signal to verify ignition and cross firing of the burners so that shutdown or other protective actions may be initiated under certain detected burner extinction conditions. Additionally, according to an example embodiment of the invention, the permissive signals (204-210) may be altered so that the process or algorithm described above may allow firing of the burners at different points in the turbine operating sequence. For example, the sequence may allow for ignition at full turbine speed.

According to certain example embodiments of the invention, the ignition detection process 200 may be configured to sense when only a partial flame or portion of a flame has been lost or gained. In accordance with an example embodiment, a derivative and magnitude change in a turbine power output signal may be monitored to determine if there has been a loss of ignition or re-ignition in one or more combustion chambers.

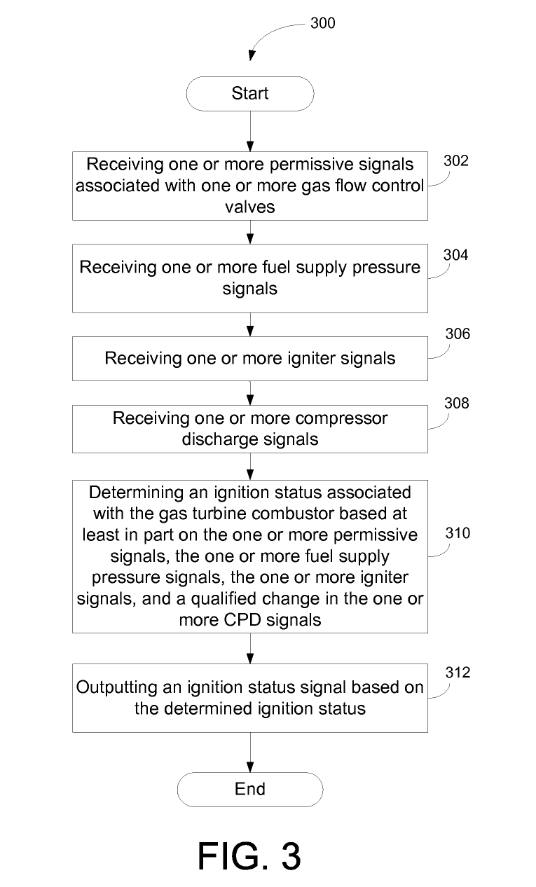

An example method 300 for confirming ignition associated with a gas turbine combustor in accordance with an embodiment of the invention will now be described with reference to the flowchart of FIG. 3. The method 300 starts in block 302, and includes receiving one or more permissive signals associated with one or more gas flow control valves. In block 304, the method 300 includes receiving one or more fuel supply pressure signals. In block 306, the method 300 includes receiving one or more igniter signals. In block 308, the method 300 includes receiving one or more compressor pressure discharge (CPD) signals. In block 310, the method 300 includes determining an ignition status associated with the gas turbine combustor based at least in part on the one or more permissive signals, the one or more fuel supply pressure signals, the one or more igniter signals, and a qualified change in the one or more CPD signals. In block 312, the method 300 includes outputting an ignition status signal based on the determined ignition status. The method 300 ends after block 312.

Accordingly, example embodiments of the invention can provide the technical effects of creating certain systems, methods, and apparatus that provide robust light-off/cross-fire detection. The detection may be based on real-time signal processing of existing cycle pressure and temperature sensors. Example embodiments of the invention can provide the further technical effects of providing systems, methods, and apparatus that may facilitate the elimination of optical-based and/or water-cooled flame detection systems in gas turbines, resulting in reduced capital and maintenance cost, and increased reliability. Example embodiments of the invention may provide the further technical effects of providing systems, methods, and apparatus that may reduce certain risks associated with operating a gas turbine.

In example embodiments of the invention, the control system 100 and the ignition detection process 200 may include any number of software and/or hardware applications that are executed to facilitate any of the operations.

In example embodiments, one or more I/O interfaces may facilitate communication between the control system 100 and the ignition detection process 200, and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the control system 100 and the ignition detection process 200. The one or more I/O interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the control system 100 and the ignition detection process 200 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ enabled network, a Wi-Fi™ enabled network, a satellite-based network, any wired network, any wireless network, etc., for communication with external devices and/or systems.

As desired, embodiments of the invention may include the control system 100 and the ignition detection process 200 with more or less of the components illustrated in FIGS. 1 and 2.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method for confirming ignition associated with a gas turbine combustor comprising:
receiving one or more permissive signals associated with one or more gas flow control valves;
receiving one or more fuel supply pressure signals;
receiving one or more igniter signals;
receiving one or more compressor pressure discharge (CPD) signals;
determining an ignition status associated with the gas turbine combustor based at least in part on the one or more permissive signals, the one or more fuel supply pressure signals, the one or more igniter signals, and a qualified change in the one or more CPD signals; and
outputting an ignition status signal based on the determined ignition status.

2. The method of claim 1, wherein a qualified change in the one or more CPD signals comprises changes above a predetermined threshold , and wherein the qualified change further comprises a CPD enablement signal, wherein the CPD enablement signal is based at least in part on the one or more permissive signals.

3. The method of claim 2, wherein the predetermined threshold comprises a signal change greater than about 4 times a noise standard deviation associated with the one or more CPD signals.

4. The method of claim 1, further comprising receiving one or more exhaust temperature signals and determining ignition associated with the gas turbine combustor based at least in part on a qualified change in the one or more exhaust temperature signals.

5. The method of claim 4, wherein the qualified change in the one or more exhaust temperature signals comprises changes above respective predetermined thresholds, and wherein the qualified change further comprises an exhaust enablement signal, wherein the exhaust enablement signal is based at least in part on the one or more permissive signals.

6. The method of claim 5, wherein the respective predetermined thresholds comprise a temperature rise of greater than about 200 degrees Fahrenheit over a time period ranging from about 5 seconds to about 20 seconds.

7. The method of claim 1, further comprising receiving one or more fuel supply valve position signals and determining the ignition status associated with the gas turbine combustor based at least in part on the one or more fuel supply valve position signals.

8. The method of claim 1, wherein receiving the one or more permissive signals comprises receiving information related to one or more of valves or sensors associated with the gas turbine combustor.

9. The method of claim 1, further comprising proceeding with a predetermined start sequence associated with the gas turbine combustor when one or more of ignition or cross firing is confirmed, and closing one or more gas flow control valves when ignition is not confirmed within a predetermined time or when flame loss is detected.

10. A system for confirming ignition associated with a gas turbine comprising:
at least one gas turbine combustor;
a plurality of sensors for detecting one or more parameters associated with the gas turbine combustor, the one or more parameters comprising:
one or more permissive signals associated with one or more gas flow control valves;
at least one fuel supply pressure signal;
at least one igniter signal; and
at least one compressor pressure discharge (CPD) signal; and
at least one processor configured to:
receive the one or more parameters from the plurality of sensors;
determine an ignition status associated with the gas turbine combustor based at least in part on the one or more permissive signals, the at least one fuel supply pressure signal, the at least one igniter signal, and a qualified change in the at least one CPD signal; and
output an ignition status signal based on the determined ignition status.

11. The system of claim 10, wherein a qualified change in the at least one CPD signal comprises changes above respective predetermined thresholds, and wherein the qualified change further comprises a CPD enablement signal, wherein the CPD enablement signal is based at least in part on the one or more permissive signals.

12. The system of claim 11, wherein the predetermined thresholds comprises signal change greater than about 4 times a noise standard deviation associated with the one or more CPD signals.

13. The system of claim 10, wherein the one or more parameters further comprise an exhaust temperature signal, and wherein the at least one processor is further configured to determine the ignition status associated with the gas turbine combustor based at least in part on an exhaust enablement signal and on a change in the exhaust temperature signal above a predetermined threshold, wherein the predetermined threshold comprises a temperature rise of greater than about 200 degrees Fahrenheit over a time period ranging from about 5 seconds to about 20 seconds.

14. The system of claim 10, wherein the one or more parameters further comprise a fuel supply valve position signal, and the at least one processor is further configured to determine the ignition status associated with the gas turbine combustor based at least in part on the fuel supply valve position signal.

15. The system of claim 10, wherein the one or more permissive signals comprise signals related to one or more of valves or sensors associated with the gas turbine combustor.

16. The system of claim 10, wherein the at least one processor is further configured to control a start sequence associated with a gas turbine based at least in part on the ignition status signal.

17. An apparatus for confirming ignition associated with a gas turbine combustor comprising:
at least one processor configured to:
receive one or more parameters from a plurality of sensors associated with the gas turbine combustor, wherein the one or more parameters comprise:
one or more permissive signals associated with one or more gas flow control valves;
at least one fuel supply pressure signal;
at least one igniter signal; and
at least one compressor pressure discharge (CPD) signal; and
determine an ignition status associated with the gas turbine combustor based at least in part on the one or more permissive signals, the at least one fuel supply pressure signal, the at least one igniter signal, and a qualified change in the at least one CPD signal; and
output an ignition status signal based on the determined ignition status.

18. The apparatus of claim 17, wherein a qualified change in the at least one CPD signal comprises changes above respective predetermined thresholds, wherein the respective predetermined thresholds comprise signal changes greater than about 4 times a noise standard deviation associated with the one or more CPD signals, and wherein the qualified change further comprises a CPD enablement signal, wherein the CPD enablement signal is based at least in part on the one or more permissive signals.

19. The apparatus of claim 17, wherein the one or more parameters further comprise an exhaust temperature signal, and the at least one processor is further configured to determine the ignition status associated with the gas turbine combustor based at least in part on an exhaust enablement signal and on a change in the exhaust temperature signal above a predetermined threshold, wherein the predetermined threshold comprises a temperature rise of greater than about 200 degrees Fahrenheit over a time period ranging from about 5 seconds to about 20 seconds.

20. The apparatus of claim 17, wherein the at least one processor is further configured to control a start sequence associated with a gas turbine based at least in part on the determined ignition status signal.
